(19) United States
(12) Patent Application Publication
(10) Pub. No.: US 2008/0178114 A1
(43) Pub. Date: Jul. 24, 2008

(54) Method for preparing a claim tree in the preparation of a patent application

(76) Inventor: Harold W. Milton, Bloomfield Hills, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/654,822

(22) Filed: Jan. 18, 2007

(51) Int. Cl. G06F 3/048; G06F 17/21

(52) U.S. Cl. 715/779; 715/200; 715/810

(57) ABSTRACT

A method and computer program for preparing a patent application including independent and dependent claims by running a software macro to display a claim dependency tree with the ability to insert word or phrases within the tree. The claim dependency tree shows a diagram of the claims within a patent application and their dependency. The user can type a claim note (42) in the Claim Note data line (38) describing the highlighted claim's limitation. The claim note (42) is then placed adjacent the claim's respective number in the claim dependency tree.

### CROSS REFERENCE TO RELATED APPLICATION

This application is related to application Ser. No. 09/273,021 filed Mar. 19, 1999 and application Ser. No. 11/300,207 filed Dec. 14, 2005.

### BACKGROUND OF THE INVENTION

1. Field of the Invention

A method of preparing a patent application including independent and dependent claims in conjunction with a word processing computer program.

2. Description of the Prior Art

A method of preparing a patent application is disclosed in U.S. patent application Ser. No. 09/273,021, filed Mar. 19, 1999, in the name of one of the inventors herein. That method includes the steps of numbering and rearranging the order of claims and duplicating claims into the specification and assigning reference numerals to elements. Further, a method of preparing a patent application is disclosed in U.S. patent application Ser. No. 11/300,207, filed Dec. 14, 2005. That method discloses the step of, running a software macro to present a tool bar in a word processing program. An option is presented in the Tool bar on a display screen of Number Claims. By selecting Number Claims in the Tool bar, a Claim Numbering data block with the claim numbers therein is presented. The Claim Numbering data block presents a List option and a Tree option for displaying a tabulation of claim numbers in the Number Claims text block in a schematically show the dependency of the claims. A Copy option is presented adjacent the Number Claims data block for copying the claim dependency tree and the claim List to the clipboard. This invention is in further perfection of the steps set forth in the aforementioned methods.

### SUMMARY OF THE INVENTION AND ADVANTAGES

This invention adds to the prior mentioned program. In the Claim Numbering data block, a Claim Note data line is presented below the Number Claims text block. By highlighting a claim number in the Number Claims text block, a claim note can be inserted in the Claim Note data line to summarize the claim limitation. The claim notes are displayed adjacent to the claim numbers in the tabulation in the Number Claims data block.

With the prior mentioned program, the invention provides efficiency in time and brings order to the preparation of a patent application. The claim tree depicts the dependency of the claims, along with the ability to change the order and/or claim dependency. This invention allows a user to insert claim notes to be viewed within the dependency tree. The claim notes are typically a single word or phrase describing the limitations of each claim. Dependant claims typically layer the novelty and progressively define the structure of the invention. In utilizing the Claim Notes function, the user can quickly recognize a claim's limitations and navigate through the independent and dependent claims with ease.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a Tool bar utilized during the method of the subject invention;

FIG. 2 is a schematic view of a Claim Numbering data block presenting claim numbers and claim notes displayed in a tabulation utilizing the Tree option;

FIG. 3. is a schematic view of a Claim Numbering data block presenting claim numbers and claim notes displayed in a tabulation utilizing the List option;

FIG. 4 is a schematic view of a Claim Numbering data block presenting the Apply Changes option;

FIG. 5 is a schematic view of an Insert Claims option block;

FIG. 6 is a schematic view of a Collect Claims warning screen;

FIG. 7 is a schematic view of a Change Claim Number option block; and

FIG. 8 is a schematic view of a Change Parent Claim option block.

### DETAILED DESCRIPTION OF THE INVENTION

Referring to the Figures, a method of preparing a patent application including independent and dependent claims is illustrated by showing the various steps in the form of computer screen displays.

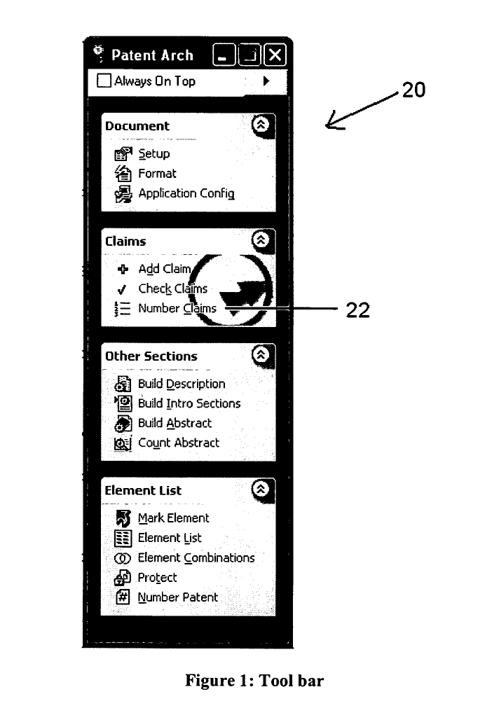

The method described is performed in conjunction with a word processing program. The program, by running a software macro, presents a Tool bar 20 in or over a word processing program to facilitate in the drafting of patent applications. The Tool bar 20 is illustrated in FIG. 1. Although this application describes a method for preparing a claim tree, the program and its Tool bar 20 also facilitate other functions such as adding claims, checking for claim errors, numbering claims, building the description, building the introduction sections, building the abstract, counting the abstract, marking elements, preparing an element list, numbering the patent, and several other functions that aid in patent drafting. These functions are covered and described in U.S. Patent Application/, filed//.

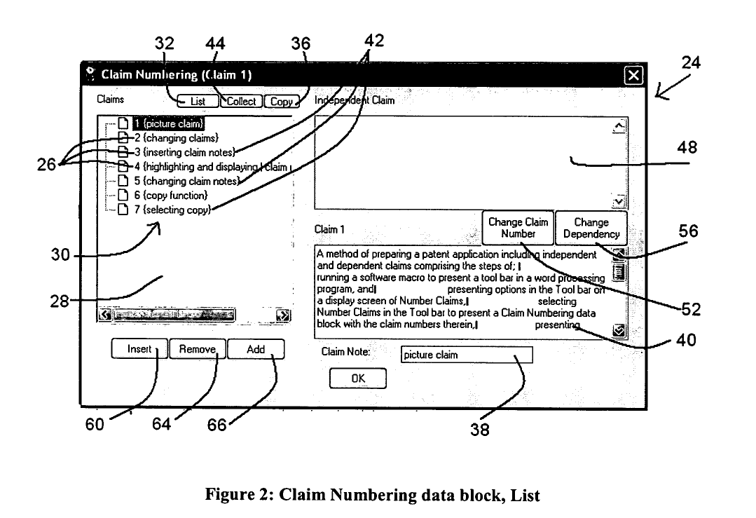

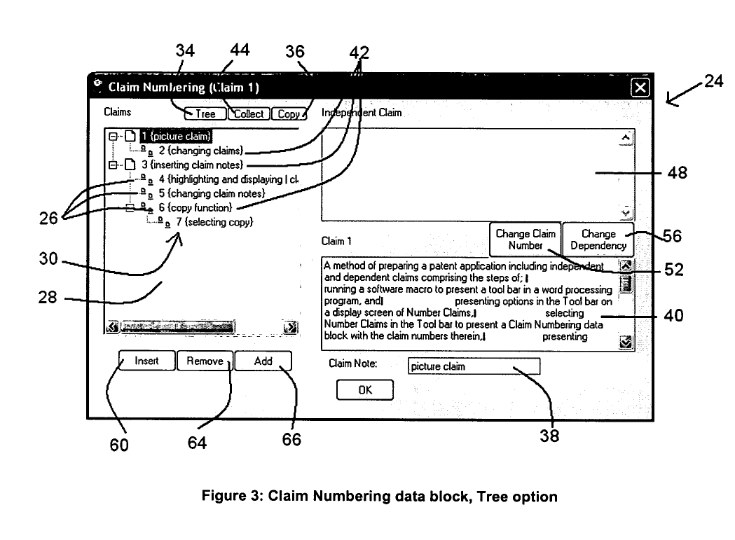

The method begins by presenting options in the Tool bar 20 on a display screen. The first step includes selecting the Number Claims option 22 in the Tool bar 20 to present a Claim Numbering data block 24 with the claim numbers 26 therein. A Number Claims text block 28 presents a tabulation 30 of independent and dependent claims, as shown in FIG. 2. Two options for viewing the tabulation 30 are presented in the Claim Numbering data block 24 include a List option 32 and a Tree option 34. By selecting the List option 32, the claim numbers 26 are displayed in a sequential list in the Number Claims text block 28, as shown in FIG. 2. By selecting the Tree option 34, the claim numbers 26 are displayed in a schematic based on dependency in the Number Claims text block 28, as shown in FIG. 3. Selecting the Copy option 36 copies the tabulation 30 to the clipboard. The clipboard temporarily stores the copied information to be pasted into a new document file. In other words, there is a copy or cut and paste operation.

The invention proceeds by presenting a Claim Note data line 38 below the Claim Number text block 40. Highlighting a claim number 26 in the Number Claims text block 28 selects a claim. A claim note 42 is inserted in the Claim Note data line 38 for summarizing the claim limitations. In other words, the operator types in a claim note 42, a single word or phrase, describing the limitation of each claim. Ideally, only one limitation will exist per claim. The claim notes 42 are displayed adjacent to the claim numbers 26 in the tabulation 30 in the Number Claims text block 28.

Another step resides in the editing of the claim notes 42 in the Claim Note data line 38 and maintaining claim notes 42 with the claim in response to changing the claim dependency and in response to changing the claim number 26. If a claim is renumbered, the claim note 42 will continue to correspond with that claim, and likewise if the dependency of a claim is changed. Since a claim note 42 essentially summarizes the claim text, it is appropriate that the claim notes 42 associate with that text.

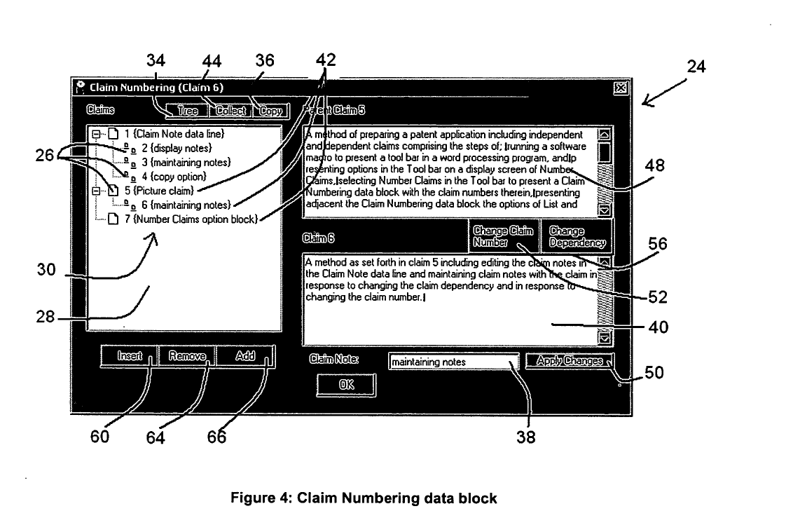

The invention also includes a computer program for preparing a patent application including independent and dependent claims and presents a screen entitled Claim Numbering data block 24, as shown in FIG. 2. The Claim Numbering data block 24 facilitates several functions of the program. A Number Claims text block 28 presents a tabulation 30 of independent and dependent claims. The tabulation 30 includes a list of the claim numbers 26 found in the Claims section of the patent application. The numbers are arranged in one of two ways to be selected by the user. A Tree option 34 presents the tabulation 30 of the claims in a tree diagram illustrating the dependency of said claims by offsetting claim numbers 26, as shown in FIG. 3 and FIG. 4. In other words, dependent claims are displayed at an indent compared to their parent claim. For instance, if Claim two is dependent on Claim one, and Claim three is dependent on Claim two, Claim number 26 two will appear below claim number 26 one and indented to the right. Claim number 26 three will appeal below claim number 26 two and indented further to the right. The Tree option 34 also compacts and arranges the current tabulation 30 of claims in a list, placing each of the dependent claims as close as possible to the parent claim from which it depends. For instance, if claim three and claim ten are dependent on claim two, the Tree option 34 would place claim three and claim ten directly after claim two, regardless of the order of the claims within the application. This view allows for easy recognition of the dependency of the claims.

The second arrangement is a List option 32, which presents the tabulation 30 in a sequential list of claim numbers 26, one below the other, as shown in FIG. 2. Unlike the Tree option 34, the claim numbers 26 are displayed in a list corresponding to the order found in the patent application. There is no indenting, and the dependent claims are listed in the order they appear in the application, apart from of their parent claim.

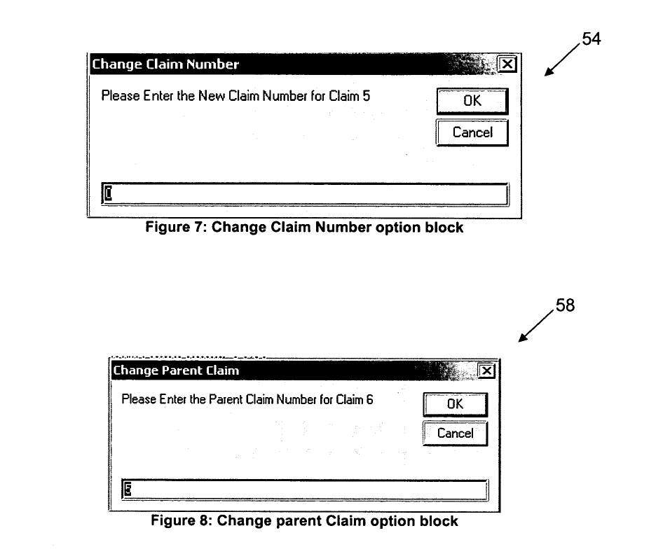

The claims can further be arranged using a Collect option 44 found in the Number Claims text block 28. The Collect option 44 should be used with caution. By selecting this option, the claims in the application will be renumbered to match the order as seen in when using the Tree option 34. When selecting the Collect option 44, a warning screen 46 will appear, cautioning the user that the program will be renumbering the claims, as shown in FIG. 6. The Collect option 44 compacts and arranges the current tabulation 30 of claims in a list, placing each of the dependent claims as close as possible to the parent claim from which it depends and renumbering the claims accordingly in the application. To reiterate, the Tree option 34 only rearranges the claims in a specific order in the Number Claims text block 28 in the Claim Numbering data block 24 for viewing, but the Collect option 44 actually rearranges and renumbers the claims in the application itself.

By selecting an independent or dependent claim in the Number Claims text block 28, the text of the claim can be viewed in the Claim Number text block 40. Additionally, when a dependent claim is selected, the text of the parent claim can be viewed in the Parent Claim text block 48. The program also allows changes to be made to the claim text of the selected claim. Once changes are made, by typing within the Claim Number text block 40, an Apply Changes option 50 is presented below the text blocks. Once this is selected, the changes will be made to the application.

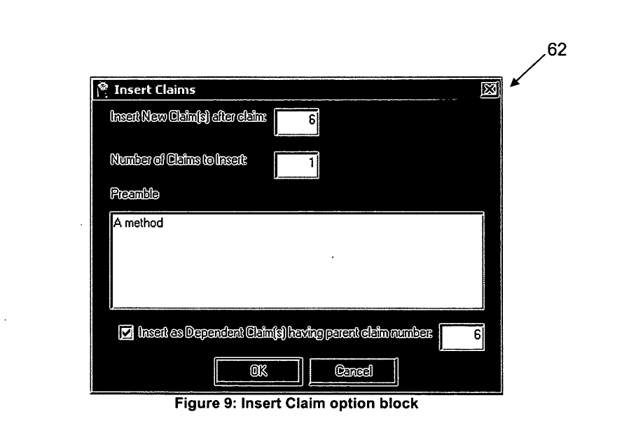

A Change Claim Number option 52 allows for the claim number 26 or location of a selected claim to be changed. By selecting the Change Claim Number option 52, a screen of a Change Claim Number option block 54 will be displayed, as shown in FIG. 7. The new claim number 26 is inserted into the data line. Once OK is selected, the claim numbers 26 are renumbered accordingly. For instance, if Claim two is renumbered to number, Claim three will become Claim two, and Claim four will become Claim three. Also, if Claim two was a parent claim to any dependent claims, the preambles of the dependent claims would now read dependent on Claim four. Subsequently, when the number of a dependent claim is changed, the preamble remains the same.

A Change Dependency option 56 allows for the dependency of a selected claim to be modified. By selecting the Change Dependency option 56, a screen of a Change Parent Claim option block 58 screen will be presented, as shown in FIG. 8. This block allows the parent claim of a dependent claim to be changed, and thus changing the preamble of the selected dependent claim. However, the parent claim must precede a dependent claim in the application for a dependent claim to be dependent on it. In other words, Claim three cannot be dependent on Claim six. Once the dependency or number of a claim is changed, the tabulation 30 will immediately update to show the latest version of the claims and their dependency.

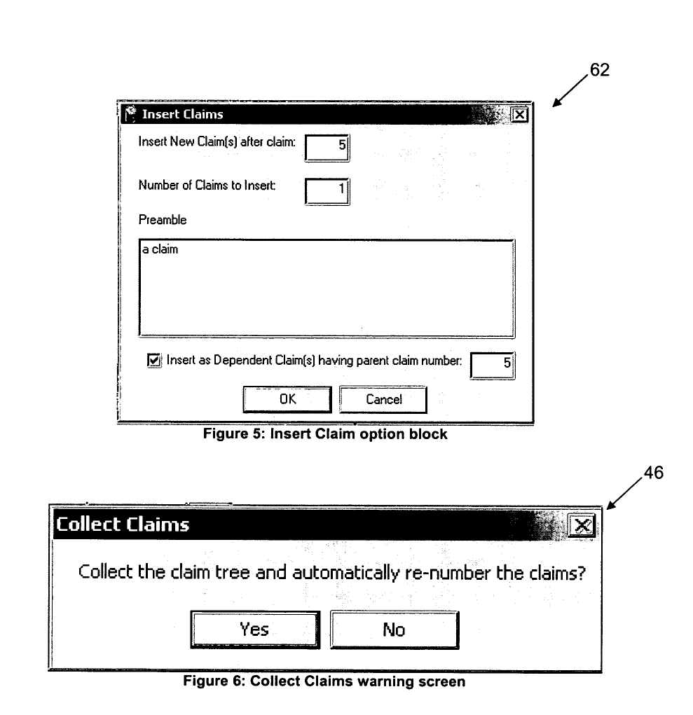

An Insert option 60 is presented and allows for the inserting of a claim or claims. By selecting the Insert option 60, a screen of an Insert Claim option block 62 is presented, as shown in FIG. 5. This option block allows the user to choose the number of claims to be inserted, after which existing claim the claim is to be inserted, the preamble of the claim to be inserted and if dependent, the parent claim number 26 of the claim to be inserted. After OK is selected, the new claim or claims will appear in the tabulation 30. The text of these claims can then be edited as discussed previously. Note that a claim must be selected prior to selecting the Insert option 60. However, the selection does not have any bearing on where the claim or claims are inserted, as this can be specified in the Insert Claim option block 62.

A Remove option 64 is presented to remove a selected claim. An Add option 66 is presented to add an independent claim at the end of the tabulation 30. For instance, selecting the Add option 66 when there are currently claims, will add a ninth claim to the list. The claim will have the generic preamble. Again, the text of the claim can be edited as described previously.

A Copy option 36 is available for copying the current view of the tabulation 30 to the clipboard. The clipboard temporarily stores the copied information to be pasted into a new document file. In other words, there is a copy or cut and paste operation.

A Claim Note data line 38 is presented for inserting a claim note 42 adjacent to a the selected claim in the tabulation 30. The claim notes 42 is a word or phrase that describes the selected claim's limitation. The note is then displayed beside the claim number 26 in the tabulation 30, utilizing both the Tree and List options 34, 32.

By copying the claim tree and pasting it in another document, the copied claim tree can be printed, showing the tabulation 30 along with the claim notes 42. This printed copy may be placed in the application file, and even submitted to the USPTO to facilitate examination.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A method of preparing a patent application including independent and dependent claims comprising the steps of;
presenting a Claim Numbering data block (24) in a word processing program,
presenting the claim numbers (26) in the Claim Numbering data block (24) in a tabulation (30) schematically showing a dependency of the claims, and
characterized by presenting a Claim Note data line (38) in the Claim Numbering data block (24), and
inserting claim notes (42) in the Claim Note data line (38) for summarizing the claim limitations and displaying claim notes (42) adjacent the claim numbers (26) in a tabulation (30) of independent and dependent claims in the Claim Numbering data block (24).

2. A as set forth in claim 1 including highlighting the claim number (26) in the Claim Numbering data block (24) and presenting a Claim Note data line (38) for inserting the claim note (42) for specific claim numbers (26) and displaying the claim notes (42) adjacent the claims numbers in the tabulation (30).

3. A method as set forth in claim 1 including editing the claim notes (42) in the Claim Note data line (38) and maintaining claim notes (42) with the claim in response to changing the claim dependency and in response to changing the claim number (26).

4. A method as set forth in claim 1 wherein the word processing program includes a clipboard and including presenting a Copy option (36) adjacent the Claim Numbering data block (24) for copying the tabulation (30) to the clipboard.

5. A method of preparing a patent application including independent and dependent claims comprising the steps of;
running a software macro to present a tool bar (20) in a word processing program, and
presenting options in the Tool bar (20) on a display screen of Number Claims,
selecting Number Claims in the Tool bar (20) to present a Claim Numbering data block (24) with the claim numbers (26) therein,
presenting in the Claim Numbering data block (24) the options of List and Tree for displaying the claim numbers (26) in a Number Claims text block (28) in a tabulation (30) schematically showing the dependency of the claims,
presenting a Copy option (36) adjacent the Number Claims text block (28) for copying the tabulation (30) to the clipboard,
selecting the Copy option (36) adjacent the Claim Numbering data block (24) to copy the tabulation (30) to the clipboard, and
characterized by, presenting a Claim Note data line (38) below the Number claims text block (28),
highlighting a claim number (26) in the Claim Number (26) claims text block,
inserting a claim note (42) in the Claim Note data line (38) for summarizing the claim limitations, and
displaying the claim notes (42) adjacent the claim numbers (26) in the tabulation (30) in the Claim Numbering data block (24).

6. A method as set forth in claim 5 including editing the claim notes (42) in the Claim Note data line (38) and maintaining claim notes (42) with the claim in response to changing the claim dependency and in response to changing the claim number (26).

7. A computer program for preparing a patent application including independent and dependent claims and presenting a screen entitled a Claim Numbering data block (24) and comprising;
a Number Claims text block (28) for presenting a tabulation (30) of independent claims and dependent claims,
a Tree option (34) for presenting said tabulation (30) of said claims in said Number Claims text block (28) in a tree diagram illustrating the dependency of said claims by offsetting claim numbers (26),
a List option (32) for presenting said tabulation (30) of said claims in said Number Claims text block (28) in a sequential list of claim numbers (26) one below each other and corresponding to claim numbers (26) in the application,
a Collect option (44) for compacting and arranging presenting said tabulation (30) of said claims in said Number Claims text block (28) in a list placing each of said dependent claims as close as possible to the parent claim from which it depends,
a Parent Claim text block (48) for presenting text of a parent claim selected in the Number Claims text block (28),
a Claim Number text block (40) for presenting text of one of said dependent claims selected in the Number Claims text block (28),
a Change Claim Number option (52) for changing and re-arranging a number of one of said claims selected in the Number Claims text block (28) and for renumbering said claims,
a Change Dependency option (56) for modifying the dependency of one of said dependent claims selected in the Number Claims text block (28),
an Insert option (60) for inserting one of said claims in the application and said tabulation (30),
a Remove option (64) for removing one of said claims from the application and said tabulation (30),
an Add option (66) for adding one of said independent claims to the application and at the end of said tabulation (30),
a Copy option (36) for copying said tabulation (30) to a clipboard and for pasting said tabulation (30) in a file,
characterized by a Claim Note data line (38) for inserting a claim note (42) including a summary of the limitation of a selected one of said claims selected in Number Claims text window and for displaying said claim note (42) adjacent said selected one of said claims selected in said tabulation (30).
